(19) United States
(12) Patent Application Publication
(10) Pub. No.: US 2015/0341536 A1
(43) Pub. Date: Nov. 26, 2015

(54) SYSTEMS AND METHODS FOR ORIENTING AN IMAGE

(71) Applicant: Mophie, Inc., Tustin, CA (US)

(72) Inventors: Daniel Huang, Irvine, CA (US); Vannin Gale, Anaheim Hills, CA (US); Kerloss Sadek, Corona, CA (US)

(21) Appl. No.: 14/675,016

(22) Filed: Mar. 31, 2015

Related U.S. Application Data
(60) Provisional application No. 62/103,912, filed on Jan. 15, 2015.
(60) Provisional application No. 62/002,693, filed on May 23, 2014.

(51) Int. Cl. H04N 5/232; G04B 47/06; H04N 5/262

(52) U.S. Cl. CPC H04N 5/2328; H04N 5/2628; H04N 5/23216; G04B 47/06

(57) ABSTRACT

Various embodiments relate to systems and methods for orienting an image captured by a camera (e.g., on a wearable computing device such as a smartwatch). The system can include an orientation sensor (e.g., one or more accelerometers) for detecting the orientation of the camera. In some embodiments, a controller can modify (e.g., crop and/or rotate) a first image captured by the camera (e.g., at a misaligned orientation) to produce a second image. In some embodiments, an actuator can move (e.g., rotate) the camera to an aligned position before the image is captured. The controller can use information from the orientation sensor to determine an amount of rotation to be applied to the camera and/or to the first image in order to orient the image at the desired orientation.

### CROSS-REFERENCE TO RELATED APPLICATIONS

The application claims the benefit of U.S. Provisional Patent Application No. 62/002,693, filed May 23, 2014, and titled SYSTEMS AND METHODS FOR ORIENTING AN IMAGE, and U.S. Provisional Patent Application No. 62/103,912, filed Jan. 15, 2015, and titled SYSTEMS AND METHODS FOR ORIENTING AN IMAGE. The entirety of each of the above-identified applications is hereby incorporated by reference and made a part of this specification.

### BACKGROUND

1. Field of the Disclosure

Some embodiments of this disclosure relate to systems and methods for orienting an image captured with a camera. The camera can be part of a mobile device (e.g., a smartphone, or a wearable computing device such as a smartwatch). An image can be oriented by software adjusting the parameters of an image captured with a camera. An image can also be oriented by mechanically altering the orientation of a camera before capturing the image.

2. Description of the Related Art

In some circumstances, the orientation of a camera can be difficult to control. If a camera is not oriented properly towards the image target, then the captured image can have an orientation different from what a user desired or intended.

### SUMMARY OF CERTAIN EMBODIMENTS

Certain embodiments are summarized below by way of example and are not intended to limit the scope of the claims.

Various embodiments disclosed herein can relate to a smartwatch that includes a wrist strap configured to couple the smartwatch to a wrist of a wearer, a camera configured to capture a first image, an orientation sensor configured to determine the orientation of the camera, a data storage element, and a controller. The controller can be configured to determine a displacement angle between the orientation of the camera determined by the orientation sensor and a target orientation and produce a second image that is rotationally offset from the first image by an amount of the displacement angle.

The controller can store the second image in the data storage element, in some embodiments. The controller can be configured to rotate and/or crop the first image to produce the second image.

The orientation sensor can include an accelerometer. The bottom edge of the second image can be substantially perpendicular to a measured force of gravity.

The smartwatch can include a wireless communication interface that can be configured to transmit the second image to a remote device. The smartwatch can include a display configured to display the second image.

The camera can be configured to capture the first image having a substantially circular shape. The camera can include a circular image capture sensor.

The controller can be configured to produce the second image such that the first image is larger than the second image by at least about 20% and by about 200% or less. The controller can be configured to produce the second image smaller than the first image such that the second image fits inside the first image in any rotational orientation.

Various embodiments disclosed herein can relate to a camera system that includes a camera configured to capture an image, an orientation sensor configured to determine an orientation of the camera, and a controller configured to orient the image based at least in part on the orientation of the camera.

The camera system can include a computer readable memory. The controller can be configured to store the captured image in the computer readable memory. The controller can be configured to store metadata associated with the captured image in the computer readable memory. The metadata can include orientation data that includes the orientation of the camera.

The camera can include a substantially circular image sensor. The orientation sensor can include an accelerometer.

The controller can be configured to orient the image by modifying the image after the camera captures the image based at least in part on the orientation of the camera. The controller can be configured to orient the image by rotating the image after the camera captures the image. The controller can be configured to crop the image.

The camera can include an actuator for moving at least part of the camera. The controller can be configured to orient the image by moving the at least part of the camera using the actuator based at least in part on the orientation of the camera before the camera captures the image. The actuator can be configured to rotate the at least part of the camera to orient the image.

The camera can include a user interface configured to receive input, and the controller can be configured to enable and disable image reorientation in response to input received by the user interface.

In some embodiments, the image can be one frame of a video recording. The camera can be configured to capture multiple images comprising multiple frames of the video recording. The orientation sensor can be configured to determine the orientation of the camera for each of the multiple images. The controller can be configured to orient each of the multiple images based at least in part on the orientation of the camera for each of the multiple images.

In some embodiments, a first set of images of the video recording can be captured in a first orientation, a second set of images of the video recording can be captured during a transition from the first orientation to a second orientation, and a third set of images of the video recording can be captured in the second orientation. The orientation sensor can be configured to determine the orientation of the camera for the first set of images, for the second set of images, and for the third set of images. The controller can be configured to reorient at least some of the images based at least in part on the determined orientation of the camera such that the first set of image, the second set of image, and the third set of images have the same orientation. The first orientation can be rotationally offset from the second orientation by an angle between about 70 degrees and about 110 degrees. The first orientation can be one of a landscape orientation and a portrait orientation, and the second orientation can be the other of the landscape orientation and the portrait orientation.

A wearable computing device can include the camera system and a coupling element configured to couple the wearable computing device to a wearer. The wearable computing device can be configured to capture an image using the camera while the wearable computing device is worn by the wearer. The wearable computing device can be a smartwatch.

Various embodiments disclosed herein can relate to a method for providing an image. The method can include receiving an instruction to capture an image, capturing a first image using a camera, determining an orientation of the camera using an orientation sensor, and producing a second image based at least in part on the first image and the orientation of the camera.

A wearable computing device can include the camera. The wearable computing device can be a smartwatch.

The first image can be substantially circular, in some embodiments.

The method can include determining a displacement angle between the orientation of the camera and a target orientation, and the second image can be rotationally offset from the first image by an amount of the displacement angle.

Producing the second image can include cropping and/or rotating the first image to produce the second image.

The method can include capturing multiple images comprising multiple frames of a video recording using the camera, determining an orientation of the camera for each of the multiple images using the orientation sensor, and reorienting at least some of the multiple images based at least in part on the determined orientation of the camera for the at least some of the multiple images.

The method can include capturing a first set of images of a video recording in a first orientation, capturing a second set of images of the video recording during a transition from the first orientation to a second orientation, capturing a third set of images of the video recording at the second orientation, determining the orientation of the camera for the images of the first set of images, the second set of images, and the third set of images, and reorienting at least some of the images based at least in part on the determined orientation of the camera such that the first set of images, the second set of images, and the third set of images have the same orientation. The first orientation can be rotationally offset from the second orientation by an angle between about 70 degrees and about 110 degrees. The first orientation can be one of a landscape orientation and a portrait orientation, and the second orientation can be the other of the landscape orientation and the portrait orientation.

The method can include storing the second image on a data storage unit. The method can include storing orientation information that includes the orientation of the camera. The method can include displaying the second image on a display. The method can include sending the second image to a remote device using a communication interface.

Various embodiments disclosed herein can relate to a method for providing an image. The method can include receiving an instruction to capture an image, determining an orientation of a camera using an orientation sensor, moving at least a portion of the camera based at least in part on the orientation of the camera, and capturing an image using the camera.

A wearable computing device can include the camera. The wearable computing device can be a smartwatch.

The method can include determining a displacement angle between the orientation of the camera and a target orientation, and moving at least the portion of the camera can include rotating at least the portion of the camera by an amount of the displacement angle.

The orientation sensor can include an accelerometer.

Various embodiments disclosed herein can relate to a computer readable non-transitory storage containing machine executable instructions configured to cause one or more hardware processors to implement the methods disclosed herein.

Various embodiments disclosed herein can relate to camera systems configured to perform the methods disclosed herein. A wearable computing device (e.g., a smartwatch) can include a camera system configured to perform the methods disclosed herein.

Various embodiments disclosed herein can relate to a system for orienting an image captured (e.g., with a smartwatch), the system can include a camera configured to capture an image, a housing for the camera configured to allow the camera to rotate within the housing about an axis of rotation, and a weight attached to the camera offset from the axis of rotation. The weight can be configured to cause a vertical axis of the camera to rotate into alignment with a direction of the force of gravity. The system can include a locking mechanism configured to prevent rotation of the camera when engaged.

Various embodiments disclosed herein can relate to a camera comprising a substantially circular image sensor configured to produce substantially circular images.

Various embodiments disclosed herein can relate to a method for orienting an image, and the method can include identifying a feature in an image, and producing a reoriented image based at least in part on the image and the orientation of the feature in the image.

The feature in the image can be a substantially linear feature, and the reoriented image can be configured such that the substantially linear feature is oriented substantially horizontally or substantially vertically. The image can be rotated and/or cropped to produce the reoriented image.

### BRIEF DESCRIPTION OF THE DRAWINGS

FIG. 1 shows an example of embodiments where a captured image can be cropped and rotated to adjust the orientation of the image.

FIG. 1A shows an example of embodiments where a larger captured image can be cropped and rotated to adjust the orientation of the image.

FIG. 1B shows an example of embodiments where a substantially round captured image can used to produce delivered images of substantially the same size at various orientations.

FIGS. 2A and 2B show examples of embodiments where an image captured by a camera on a smartwatch can be displayed with an orientation corresponding to the target orientation.

FIG. 3 shows a schematic example of embodiments of an image orientation system.

FIGS. 4A and 4B show an example of embodiments where an image captured by a camera on a smartwatch can be oriented by rotating a camera about at least one axis.

FIG. 5 shows a schematic example of embodiments of an image orientation system including an actuator.

FIG. 6 shows a flow chart example of some embodiments of methods for orienting an image captured by a camera.

FIG. 7 shows an example of embodiments of a camera orientation system configured to allow a camera to rotate about at least one axis in response to the force of gravity.

### DETAILED DESCRIPTION OF CERTAIN EMBODIMENTS

Cameras can be installed on small personal electronic devices such as a cellular phone or a smartphone. Similarly, a camera can be installed on a wearable computing device (e.g., a smartwatch). A smartwatch (which can be analogous to a smartphone) can be any watch that includes some computing or communication function, in addition to its function as a timekeeping watch. For example, a smartwatch can communicate (e.g., wirelessly) with a smartphone or other mobile electronic device (e.g., to relay information relating to phone calls, text messages, emails, calendar notifications, etc.) Although various embodiments are disclosed herein in connection with a camera on a smartwatch, many other types of wearable computing devices can be used (e.g., including devices that do not tell time). Also, various embodiments relate to orienting an image captured by a camera regardless of whether or not the camera is incorporated into a smartwatch, wearable computing device, or mobile electronic device, etc. In some circumstances, it can the orientation of a camera can be difficult to control. For example, a smartwatch can be configured for a user to wear the smartwatch on his or her wrist during use of the smartwatch, and this can including wearing the smartwatch while using a camera installed on the smartwatch to capture an image. When worn on a user's wrist, the orientation of a camera may be difficult to determine or control. Various embodiments disclosed herein relate to adjusting the orientation of images captured by a camera (e.g., on a smartwatch). The systems and methods disclosed herein can enable a user to take pictures having a desired orientation (e.g., oriented horizontally, in landscape orientation, in portrait orientation, with a bottom edge perpendicular to the direction of gravity, etc.) even when the user holds the device (e.g., the smartwatch) at a position that is offset from the desired or target orientation.

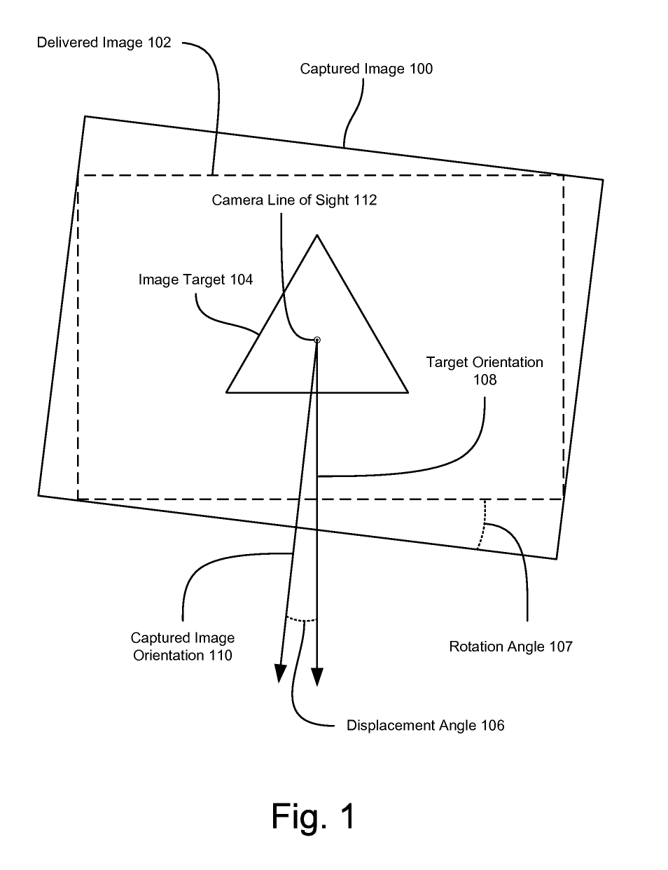

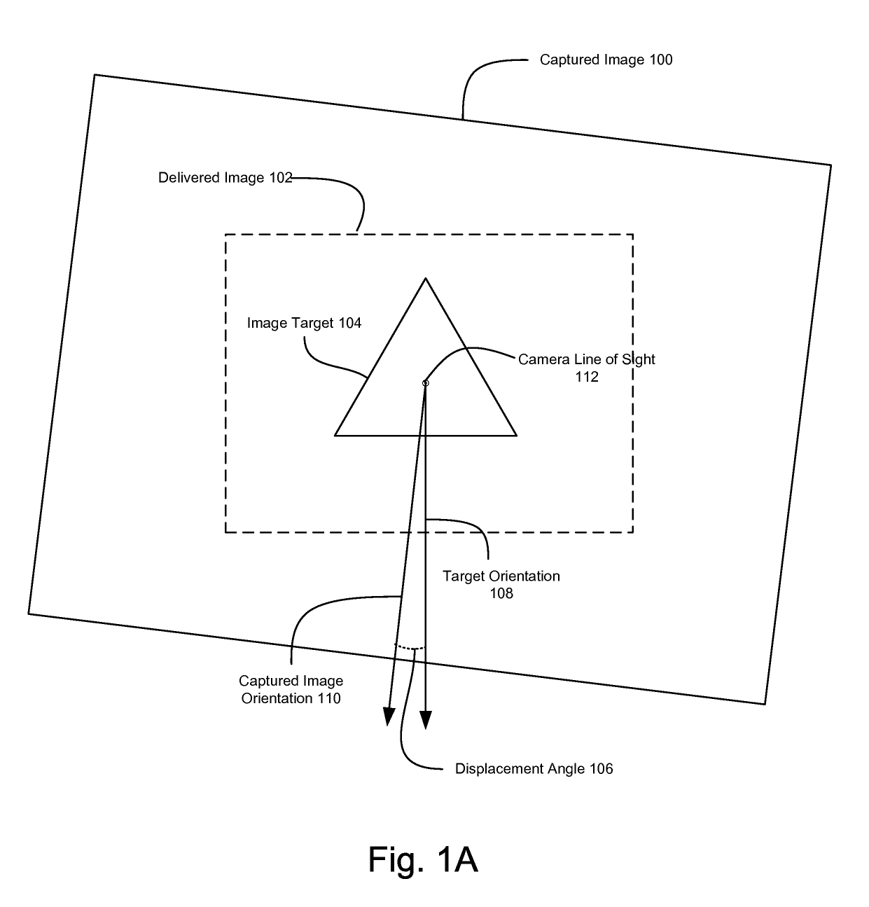

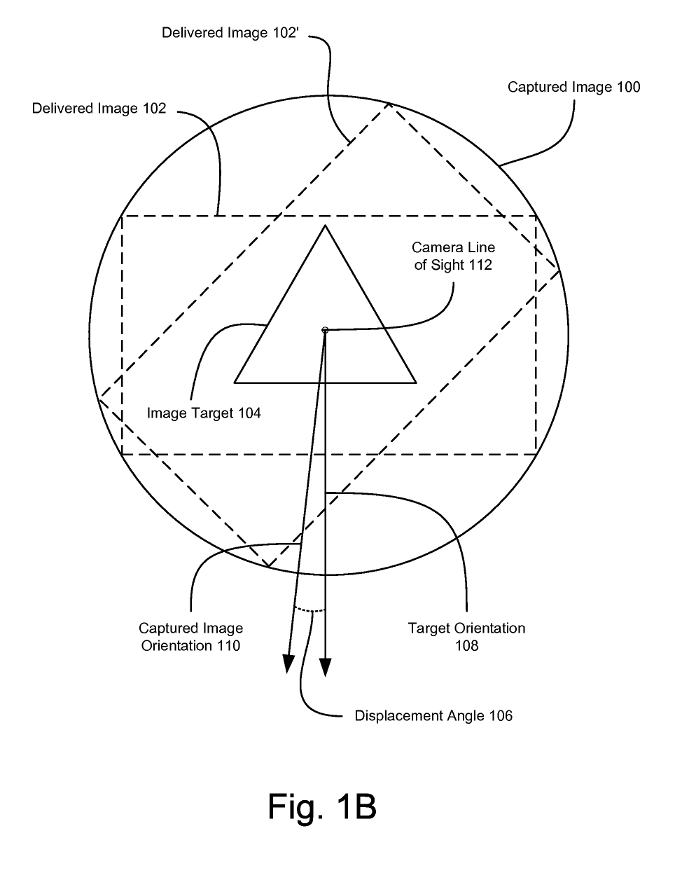

FIG. 1 shows an example embodiment where a captured image 100 (sometimes referred to herein as a first image) can be adjusted to a delivered image 102 (sometimes referred to herein as a second image). A camera can capture an image 100 while positioned at an orientation 110 different from a target orientation 108. In FIG. 1, the captured image orientation 110 and target orientation 108 are shown as directional vectors coming out of an axis of rotation. The axis of rotation can be normal to the plane of captured image 100 and can be centered with captured image 100. In some embodiments, as in FIG. 1, the axis of rotation can be the camera line of sight 112, shown coming out of the page in FIG. 1. The vector showing the target orientation 108 can point directly downward (e.g., in the direction of the pull of gravity). The vector representing the target orientation 108 can point in the direction of a measured acceleration (e.g., gravity), as measured, for example, by an accelerometer. The vector showing the captured image orientation 110 can point from a top of the camera to the bottom of the camera, for example, such that the vector showing the captured image orientation 110 would point in the same direction (e.g., straight down) as the vector for the target orientation 108 if the camera were positioned flat. In some embodiments, the vector representing the captured image orientation 110 can be perpendicular to a bottom edge of the image sensor at the time the image is captured.

The difference between the captured image orientation 110 and the target orientation 108 can define a displacement angle 106 (e.g., about the camera line of sight 112). Some embodiments can provide a delivered image 102 aligned with the target orientation 108 even where the captured image orientation 110 does not originally correspond to the target orientation 108. In order to adjust the orientation of the captured image 100, the image can be rotated by a rotation angle 107, which can be equal to displacement angle 106. The angle 107 between the boundaries of the resulting delivered image 102 and those of the captured image 100 can in some embodiments be equal to the displacement angle 106 between the captured image orientation 110 and the target orientation 108.

Rotating the orientation of a delivered image 102 can cause the boundaries of the delivered image 102 to exceed the scope of the captured image 100 in some areas. To avoid including blank space in those areas of the delivered image 102 extend past the boundaries of the captured image 100, the delivered image 102 can be cropped. FIG. 1 shows an example embodiment where the delivered image 102 has been cropped so that its boundaries do not exceed the boundaries of a captured image 100. In some embodiments a delivered image 102 can be cropped down to the largest size possible such that when rotated an amount equal to displacement angle 106, the delivered image 102 fits entirely within the boundaries of a captured image 100. The delivered image 102 can in some embodiments be centered on the same point as the captured image 100. Because of the cropping, in some embodiments, the resulting delivered image 102 can have a lower resolution than the captured image 100.

Cropping can mean removing portions of a captured image 100 (e.g., along its boundaries). Cropping and rotating can be used to adjust a captured image 100 to a delivered image 102 in any order. Where the displacement angle 106 is known, the amount that will need to be cropped from a captured image 100 can be calculated before or after rotating. In some embodiments the cropping of an orientated image 102 can be accomplished by removing calculated portions from the captured image 100. The portions removed from the captured image 100 can be uniform portions along the perimeter of captured image 100, and in some embodiments can be non-uniform portions. The delivered image 102 can be produced from the captured image 100 in multiple ways, including by removing rectangular portions from the perimeter of a captured image 100 before rotating the captured image 100. In some embodiments the delivered image 102 can be produced in part by removing triangular portions along the boundary of the captured image 100 (e.g., after rotation of the captured image 100). In some embodiments a captured image 100 can be adjusted (e.g., by cropping, rotating, or both) iteratively in multiple steps to result in the delivered image 102.

A larger image sensor can be configured to provide a larger captured image 100. FIG. 1A shows an example of embodiments where an image sensor provides a captured image 100 much larger than the delivered image 102. In some embodiments a larger captured image 100 can be cropped to a result in a delivered image 102 with a determined size and resolution. The size ratio of captured image 100 to delivered image 102 can be selected, in some embodiments, such that rotating the orientation of a delivered image cannot cause the boundaries of the delivered image 102 to exceed the scope of the captured image 100. For example, an image sensor can be configured to provide a captured image 100 that is known percentage larger than the determined size for delivered image 102 (e.g., having a 20% larger area). In some embodiments an image sensor can be configured to provide a captured image 100 that larger than the delivered image 102 by at least about 10%, by at least about 20%, by at least about 30%, by at least about 50%, by at least about 100%, by at least about 150%, by at least about 200%, by about 500% or less, by about 400% or less, by about 300% or less, by about 200% or less, by about 150% or less, by about 100% or less, by about 75% or less, by about 50% or less, by about 25% or less, although values outside these ranges can be used in some implementations. In some embodiments, the captured images can be sufficient larger than the delivered image that the delivered image can be rotated to any rotational orientation while fitting inside the bounds of the captured image. In some embodiments, the captured image and/or the image sensor can be rectangular. In some embodiments, the smallest distance across the captured image 100 (e.g., the smaller of the height and width of the captured image 100) can be at least as large as the largest distance across the delivered image 102 (e.g., the diagonal distance between two corners of the delivered image 102). In some embodiments, the larger captured image 100 can be cropped to a size smaller than needed to prevent the boundaries of the rotated delivered image 102 to exceed the scope of the captured image 100. In some embodiments the uncropped captured image 100 or a portion thereof can be electronically stored for later restoration. In some embodiments, the system can be configured to provide delivered images 102 having substantially the same size regardless of how much rotation was applied to produce the delivered images 102. By comparison, in some embodiments (such as shown in FIG. 1), the delivered image 102 can be made to have the largest size possible while being contained within the bounds of the captured image 100, which can result in delivered images 102 that are smaller in size as more rotation is applied.

In some embodiments, an image sensor can be configured to provide a captured image with a substantially round shape. An image sensor can have a substantially round shape. FIG. 1B shows an example of embodiments where captured image 100 has a substantially circular shape. In some embodiments, captured image 100 can comprise a substantially round border made up of comparatively small rectangular steps (e.g., rectangular pixels arranged to form a substantially round or circular border). In some embodiments, the use of a substantially round captured image 100 can be used to produce delivered images 102 having substantially the same size regardless of how much rotation is applied to produce the delivered images 102. As can be seen in FIG. 1B, the substantially round captured image 100 can be rotated about the camera line of sight 112 from the captured image orientation 110 to the target orientation 108, without substantial changes to the size or shape of the captured image 100, due to the substantially circular shape of the captured image. Delivered images 102 of substantially the same size can be extracted from the captured image 100 are various different orientations (e.g., see delivered images 102 and 102′ in FIG. 1B). In some embodiments, the pixels of the delivered image 102 can be produced by interpolating data from the pixels of the captured image 100, to produce the delivered image 102 having a different orientation (e.g., offset by the displacement angle 106) than the captured image 100. In some embodiments, the captured image can be raw data from the image sensor and the raw data can be used to generate pixels having the orientation appropriate to produce the delivered image 102. An image captured using the substantially circular image sensor can be toggled between landscape and portrait orientations, and can be oriented at any position therebetween (e.g., without reducing the size of the image).

Target orientation 108 and captured image orientation 110 can be compared by detecting the orientation of a camera (e.g., rotationally around at least one axis). The axis of rotation can be the central axis normal to the plane of the captured image 100 (e.g., normal to a surface of an image sensor), which can correspond to the camera line of sight 112. The captured image orientation 110 can be established along the vertical axis of the camera (e.g., perpendicular to the bottom edge of the image sensor). In some embodiments target orientation 108 can be in the same direction as the measured directional pull of gravity (e.g., as measured by an accelerometer). Various embodiments herein discuss determination of the orientation of the camera based on a measured pull of gravity. It will be understood that the measured direction of the pull of gravity may be different than the actual direction of the pull of gravity in some instances (e.g., when the camera is being moved around by the user). The displacement angle 106 can equal the angular deviation of the measured directional pull of gravity from the vertical axis of the camera. Where the measured directional pull of gravity is detected as a three-dimensional vector, the target orientation 108 can be established as the directional components of the measured force of gravity in the same plane as the captured image 100 (e.g., in the same plane as a surface of the image sensor). In some embodiments orientation adjustments can be made relative to three-dimensional orientations of the target orientation 108 and the captured image orientation 110. In some embodiments, the orientation adjustments can be made relative to the two-dimensional orientations of the target orientation 108 and the captured image orientation 110. For example, the image adjustment can correct for the camera being titled to the right or left (e.g., rotated clockwise or counterclockwise about the camera line of sight 112), while not correcting for the camera being angled upward or downward. In some embodiments, one or more accelerometers that measure acceleration in at least one direction (e.g., in three directions) can be used to determine the measured direction of the force of gravity. One or more accelerometers can be used as an orientation sensor to determine the measured directional pull of gravity. In some embodiments the displacement angle 106 between the measured directional force of gravity and the vertical axis of the camera can be calculated using information received from the one or more accelerometers.

The adjustment from captured image 100 to delivered image 102 shown in FIGS. 1, 1A, and 1B can be performed by one or more processors. The one or more processors performing the adjustments to the image can be part of a mobile device (e.g., a smartphone, a smartwatch, a hand-held digital camera), a general purpose computer, any other device configured to receive, analyze, or adjust a digital image, or a component thereof. The one or more processors can determine based on the input displacement angle 106 and the parameters of a captured image 100 what adjustments to the captured image 100 will provide an image oriented along the target orientation 108. A machine or computer (e.g., a smartwatch, a smart phone, or a PC) receiving the captured image 100 can in some embodiments utilize one or more image processors to implement the calculated adjustments and provide an oriented delivered image 102.

In some embodiments, orientation data for a captured image 100 can be electronically stored as metadata associated with an image. Orientation data can comprise information relating to the target orientation 108, the captured image orientation 110, the displacement angle 106, the amount of rotation and/or cropping performed to produce the delivered image 102, or some combination thereof. Adjustments to the orientation of captured image 100 or delivered image 102 can be performed by later reference to the stored orientation data. Stored orientation data can be configured to allow a user to toggle between an adjusted and unadjusted image (e.g., between the captured image 100 and the delivered image 102, or between the delivered image and a modified version of the delivered image 102, etc.). In some embodiments, adjustments to the orientation of captured image 100 or delivered image 102 can be performed by later comparison of a second target orientation with captured image orientation 110, target orientation 108, or both. A second target orientation can be selected after an image is captured and/or delivered. In some embodiments a second target orientation can be the same as or different from either captured image orientation 110 or target orientation 108.

If orientation data was not initially stored for a captured image 100, in some embodiments orientation data can be estimated from the features of a captured image 100. In some embodiments, estimating orientation data can comprise estimating a target orientation 108 corresponding to the direction of gravity about the camera line of sight 112 in the plane of the captured image 100, although various other target orientations can be used. In some embodiments, the target orientation 108 can be estimated based on any of the following, or combinations thereof: detection of a horizon line in the image (e.g., a horizon); identified features of structures (e.g., windows or edges on a building, ceilings, floors) in the image; identified written characters in the image; orientation of a person's identified features (e.g., eyes, nose, mouth, head, legs) in the image; detected motion directions in a video; or identified light features (e.g., shadows, light sources) in the image. In some embodiments, an estimated target orientation 108 based on identified image features can be suggested to a user for confirmation prior to cropping or rotating captured image 100. A user can alter the estimated target orientation 108 to change the adjustments (e.g., cropping, rotating) to the captured image 100. In some embodiments, a camera or a computing device can analyze an image to identify one or more of the features identified above, and can adjust the orientation of the image based on the orientation of the one or more features. For example, a horizon can be identified in an image, and the image can be adjusted (e.g., rotated and/or cropped) such that the horizon is oriented horizontally in the adjusted image. In some embodiments, the camera or computing device can produce multiple adjusted images and can present the multiple adjusted images to a user and enable the user to select one of the of the multiple adjusted images (e.g., via a user interface). For example, a generally linear feature can be identified in an image, and the camera or computing device can produce a first adjusted image with the linear feature oriented horizontally (e.g., corresponding to the linear feature being a horizon) and a second adjusted image with the linear feature oriented vertically (e.g., corresponding to the linear feature being a side of a building). In some embodiments, the image reorientation can be performed without orientation data (e.g., from an accelerometer).

The adjustments described above for translating a captured image 100 into a delivered image 102 (e.g., by cropping and/or rotating) can be performed on one or more frames of a recorded video, and in some embodiments on each frame in a recorded video. In some embodiments, a user can select which frames from a video recording are to be adjusted. The captured image orientation 110 for at least one frame in a video can be compared with a target orientation 108, and in some embodiments the orientation of the frame or frames can be adjusted as described herein (e.g., by cropping and rotating the frame). In some embodiments, the target orientation 108 can be the same for each frame in a recorded video, and in some embodiments one or more frames in the recorded video can have different target orientations 108. The target orientation 108, in some embodiments, can be a user-selected orientation. In some embodiments, the target orientation 108 for each frame can be the detected direction of gravity about the camera line of sight 112 in the plane of the captured frame at the time the frame were captured. The target orientation 108 can be determined from information provided by an accelerometer. In some embodiments, each frame can have orientation data stored as metadata. In some embodiments, each frame can have information associated with the detected direction of gravity at the time the frame was captured stored as metadata. At least one or more frames may be adjusted (e.g., cropped, rotated) so that the entire recorded video has uniform display parameters (e.g., screen height and width, resolution). In some embodiments, one or more frames can be adjusted to provide a video with uniform display parameters, even though one or more of the frames adjusted already have an orientation aligned with the target orientation 108.

A camera may be intentionally moved during the recording of a video, including the rotation of the camera's orientation. For example, a hand-held camera could be rotated between a landscape and portrait orientation during the recording of a video image. In some embodiments, one or more video image frames can be cropped and/or rotated in order to maintain a uniform video display (e.g., screen height and width, image orientation, image resolution) despite an intentional change in the camera's orientation. In some embodiments information about detected changes in orientation can be stored in the metadata of a captured video recording. A user can use stored metadata about changes in orientation to toggle between adjusted and unadjusted versions of the video recording.

In some embodiments a wearable computing device (e.g., a smartwatch) includes the camera and one or more processors configured to adjust a captured image 100 into a delivered image 102. The one or more processors used to perform the adjustments described in some embodiments can be special purpose hardware processors (e.g., one or more application specific integrated circuits (ASICs). The image adjustment can in some embodiments be implemented as a software program or algorithm (e.g., stored in non-transitory computer-readable storage), which in some cases can be implemented on one or more computer processors (e.g., on a general purpose computer processor).

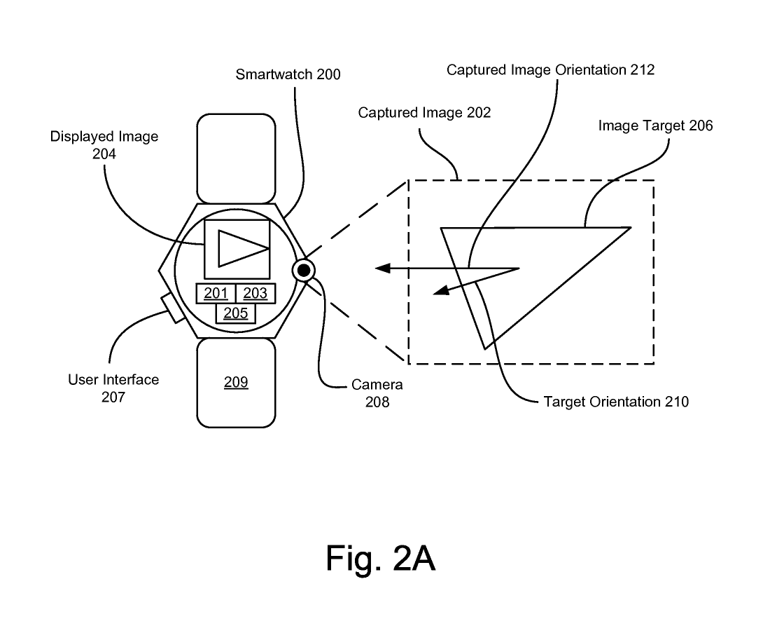

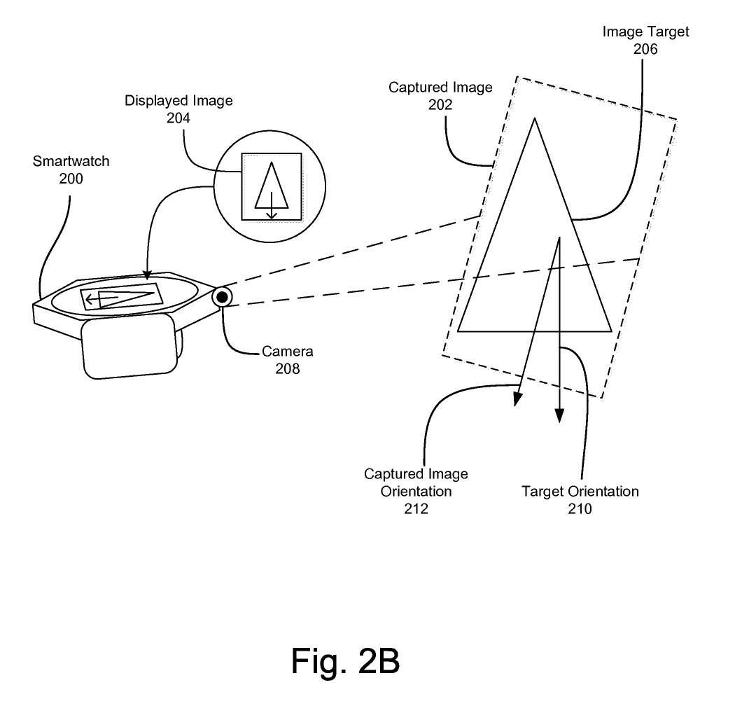

A wearable computing device (e.g., a smartwatch 200) can be used as shown in FIGS. 2A and 2B to capture an image 202 and deliver a reoriented image as a displayed image 204. The smartwatch 200 can include a controller 201 (e.g., enclosed in a housing of the smartwatch 200), which can include one or more processors. The smartwatch 200 can include computer readable memory 203, which can include one or more non-transitory memory modules, in communication with the controller. In some embodiments, the memory 203 can include executable instructions that are executable by the controller 201 to implement the features described herein. The smartwatch 200 can include a wearable coupling element 209 (e.g., a strap) configured to enable a user to wear the smartwatch 200. The wearable coupling element 209 can include a clasp, hook-and-loop fasteners (e.g., Velcro), or other releasable elements such that the smartwatch 200 can be removably worn by the user.

The smartwatch 200 or a processor included in the smartwatch 200 can provide instructions to capture an image to camera 208. Although not pictured, user instructions can be received through a user interface 207 associated with smartwatch 200, which can be configured to relay instructions to the controller 201 or to a camera 208. A user interface 207 associated with smartwatch 200 can be configured to receive a variety of instructions from a user, such as instructions to capture an image and/or to enable/disable image orientation adjustments. The user interface 207 can include one or more buttons, dials, or other user input elements. In some embodiments, the display 204 and user interface 207 can both be incorporated into a touchscreen.

As shown in FIGS. 2A and 2B, the orientation of the smartwatch 200 and the camera 208 when capturing an image 202 may cause the captured image orientation 212 to be different from the target orientation 210. In some embodiments the captured image 202 can be cropped and rotated to produce a displayed image 204 oriented in line with target orientation 210. The controller 201 can in some embodiments calculate what adjustments (e.g., cropping and rotating) for captured image 202 will produce an image oriented along the target orientation 210. As discussed above regarding FIG. 1, the calculation of the cropping and rotating of a captured image can be based at least in part on the angular difference between captured image orientation 212 and target orientation 210.

In some embodiments smartwatch 200 can include an orientation sensor 205, which can provide information regarding the orientation of the smartwatch 200 and/or camera 208. The orientation sensor 205 can be used to determine an offset between the target orientation 210 and the captured image orientation 212. As described herein, in some embodiments, an orientation sensor 205 can include one or more accelerometers. In some cases, the target orientation 210 can be such that the bottom of the image is perpendicular to the direction of the force of gravity. As discussed herein, the captured image orientation 212 can in some embodiments be established as along the vertical axis of camera 208.

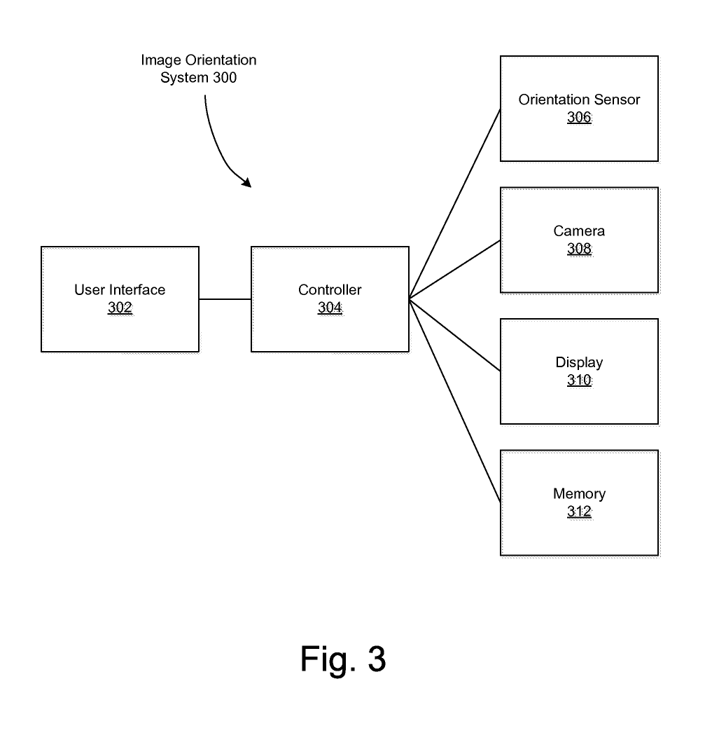

FIG. 3 shows a schematic example of some embodiments of an image orientation system 300 that in some embodiments can be used to orient an image captured with a camera 308 (e.g., on a smartwatch). An image orientation system 300 can in some embodiments orient an image captured using a hand-held digital camera, a smartwatch, or a smartphone. The image orientation system 300 can include a user interface 302, a controller 304, an orientation sensor 306, a camera 308, an image display 310, and computer readable memory 312. Additional components can be included. In some embodiments one or more of the listed components can be omitted. The components of an image orientation system 300 can communicate and exchange data or instructions between each other through wired connections, or in some embodiments through wireless connections.

The components of the image orientation system 300 can be included in a wearable computing device, such as a smartwatch. In some embodiments, at least one of the components of the image orientation system 300 can be included on a smartwatch while one or more components of the image orientation system can be include on a separate device. In some embodiments, one or more of the components of an image orientation system can be included in a smartphone. In some embodiments one or more of the components of an image orientation system can be included in a general-purpose computer. In some embodiments one or more of the components of an image orientation system can be included a hand-held digital camera.

The user interface 302 can be configured to receiver user instructions and provide those instructions to a controller 304. The user interface 302 can be configured to receive instructions from a user in a variety of forms, including button selection, software applications, voice commands, textual instructions, or other forms of user input. In some embodiments the user interface 302 can be part of a separate device configured to communicate with a controller 304. In some embodiments a user interface 302 on one device can be configured to receive instructions from a user via wireless communications with a second device. The user interface 302 can be part of a smartwatch. In some embodiments the user interface 302 can be part of a separate device configured to communicate with a controller 304 on a smartwatch. In some embodiments the user interface 302 can be part of a mobile device (e.g., a smartphone, smartwatch, or hand-held digital camera). In some embodiments the user interface 302 can be part of a separate device configured to communicate with a mobile device.

A user can provide a variety of instructions to an image orientation system 300 via the user interface 302. A user can request via a user interface 302 that an image be captured by the camera 308. In some embodiments a user can enable or disable the image reorientation features described herein (e.g., cropping or rotating of an image captured by the camera 308) through a user interface 302. The user interface 302 can be configured to allow a user to enable or disable any component of an image orientation system 300. After viewing a cropped and rotated image, a user can request via the user interface 302 that the adjustments to the image be undone. In some embodiments a user can instruct an image orientation system to toggle between the adjusted and unadjusted image. A user interface 302 can be configured to provide a user with a variety of options regarding an image including display, delivery, storage, deletion, or sharing options for the image.

Based on user instructions from the user interface 302, a controller 304 can capture, adjust, and deliver an image. In some embodiments a controller 304 can capture, deliver, or adjust an image without user instructions. The controller 304 can instruct a camera 308 to capture an image and deliver the image to the controller 304. A controller 304 can be configured to store data including image data from the camera 308. In some embodiments, a controller 304 can deliver the image as digital data to a memory module 312. A memory module 312 can be included on the same device as a controller 304, which can be a mobile device (e.g., a smartphone, smartwatch, or hand-held digital camera). In some embodiments the memory 312 can be part of a separate device in wireless communication with controller 304. In some embodiments, a user interface 302, controller 304, and memory 312, can be part of a general-purpose computer configured to communicate with a camera 308 and/or an orientation sensor 306.

The controller 304 can determine the orientation of the camera 308 based on information provided by an orientation sensor 306 (e.g., when instructing a camera 308 to capture an image). An orientation sensor 306 can be at least one accelerometer. In some embodiments a controller 304 can perform computations to determine the angular displacement of the vertical axis of the camera 308 from the directional pull of gravity based on the data collected by an orientation sensor 306. Data related to the orientation of camera 308 can be stored by a controller 304. Data related to the orientation can be delivered to memory 312.

Based on the orientation of the camera 308, as determined via the orientation sensor 306, a controller 304 can determine what adjustments to an image captured by the camera 308 will provide an image oriented with a target orientation. In some embodiments, the controller 304 can determine what adjustments are called for according to the manner described above (e.g., with reference FIG. 1). The controller 304 can perform adjustments to a captured image including rotating the image, cropping the image, or both. The controller 304 can rotate the captured image about at least one axis an angular amount equal to the displacement angle between the detected directional pull of the force of gravity and the vertical axis of the camera 308, and in some cases can crop the image until the boundaries of the rotated image are entirely within the scope of the captured image (e.g., as shown in FIG. 1). In some embodiments, the axis can be the central axis out of the captured image corresponding to the line of sight of the camera 308.

A camera 308 can provide a continuous video image stream. In some embodiments a controller 304 can continuously orient the video image stream or frames from the video image stream dynamically in response to any continuing changes in orientation detected by the orientation sensor 306. In some embodiments the display 310 can display an image dynamically captured by the camera 308 and reoriented by a controller 304. A stream of images captured by a camera 308 can be displayed on the display 310 before a request is made via the user interface 302 to capture an image (e.g., comprising the currently displayed image). A continuously displayed video image stream can enable a user to aim the camera 308 more precisely before selecting an image to capture more permanently. In some embodiments the quality of the images displayed in a continuous stream may be lower than the quality of the final captured image. Continuous streams of video images can be recorded and stored in memory 312 and in some embodiments can be stored after being reoriented (e.g., cropped and/or rotated).

An image orientation system 300 can be configured to capture and display images as a video recording. The orientation sensor 306 can be configured to detect the orientation of camera 308 for each frame in a video image recording, and in some embodiments associate this orientation data in the metadata for the video image recording. The controller 304 can be configured to stabilize the entire video image recording by adjusting the orientation for one or more frames in a video recording. In some embodiments, a user can select which frames from a video recording are to be adjusted. A controller 304 can be configured to rotate and/or crop one or more frames of a video recording based on a comparison of stored orientation data for the one or more frames with a target orientation. In some embodiments, the controller 304 can be configured to adjust one or more frames based on orientation data from a plurality of frames. The target orientation, in some embodiments, can be selected by a user. In some embodiments, the detected orientation for one or more frames can be the detected direction of gravity relative to camera 308 at the time the one or more frames were captured. By way of example, the target orientation can be to have the camera in landscape orientation with the bottom of the image sensor aligned horizontally (e.g., with the bottom of the image sensor perpendicular to the direction of gravity). The detected orientation can be obtained from an accelerometer or other orientation detection element, and the detected orientation can be the determined direction of gravity, which in this example can be offset from the target orientation by a displacement angle 106 because the camera is positioned at an angle instead of being positioned properly (e.g., in true landscape orientation). The system can capture a captured image 100 when the camera is at the offset position, and can reorient the image (e.g., by rotating and/or cropping the image) to produce the delivered image 102. The system can be used to reorient a single image, or a series of images that make up a video. When correcting orientation for a series of images that make up a video, the system can remove shaking or otherwise stabilize the resulting video. A controller 304 can in some embodiments identify a substantial rapid change in orientation of camera 308 as a potential intentional rotation. When a potential intentional rotation is detected, in some embodiments a controller 304 can rotate and/or crop one or more captured image frames to deliver a video image with uniform orientation and display parameters (e.g., screen height and width, image resolution).

Before adjusting an image, in some embodiments, the controller 304 can deliver a copy of the image to store in memory 312. A user, via the user interface 302, can instruct the controller to recall and deliver a stored unadjusted image. Orientation data for an image (e.g., the detected orientation of the camera when the image was captured) can also be stored in the metadata associated with the image. In some embodiments controller 304 can be configured to return an adjusted image to its original orientation at least in part by referencing to the stored orientation data in the metadata. In some embodiments, data sufficient to restore any cropped portions of an adjusted image can also be stored with the adjusted image. In some embodiments, a user can toggle between an adjusted and unadjusted image (e.g., the captured image 100 and the delivered image 102), either using the same image orientation system 300 as used to capture the image, or using a different system having access to the image. A substantially round image sensor, as discussed herein, can in some embodiments further facilitate alteration of the image orientation after the initial capture and storage of an image, for example because a delivered 102 image in landscape orientation (e.g., image that is wider than it is tall), in portrait (e.g., image that is taller than it is wide), or any position between landscape orientation and portrait orientation can be produced from the substantially circular captured image 100. A video captured using the substantially circular image sensor can be toggled between landscape and portrait orientations (e.g., without reducing the size of the video images). In some implementations, the orientation can be changed without using orientation data (e.g., from an accelerometer). For example, the video images can be rotated by about 90 degrees to change between landscape and portrait orientations. If orientation data is available for the video images (e.g., provided by an accelerometer), the individual video images can be reoriented individually to align with a desired orientation. By way of example, if a video is captured having a first set of images captured in a first orientation (e.g., landscape orientation), a second set of images captured during a transition from the first orientation (e.g., landscape orientation) to the second orientation (e.g., portrait orientation), and a third set of images captured in the second orientation (e.g., portrait orientation), the system can reorient at least some of the images such that the first and second and third sets of images have the same orientation. The first orientation can be rotationally offset from the second orientation by an angle of at least about 10 degrees, at least about 30 degrees, at least about 50 degrees, at least about 70 degrees, at least about 80 degrees, at least about 90 degrees, at least about 100 degrees, at least about 110 degrees, at least about 130 degrees, at least about 150 degrees, at least about 170 degrees, less than or equal to about 170 degrees, less than or equal to about 150 degrees, less than or equal to about 130 degrees, less than or equal to about 110 degrees, less than or equal to about 100 degrees, less than or equal to about 90 degrees, less than or equal to about 80 degrees, less than or equal to about 70 degrees, less than or equal to about 50 degrees, less than or equal to about 30 degrees, although values outside these ranges can also be used in some implementations.

A controller 304 can also be configured to determine before adjusting an image whether a user has disabled orientation adjustment of the image. In some embodiments the calculated adjustments to an image may exceed a previously established maximum tolerable adjustment. A maximum tolerable adjustment can be established based on a maximum rotation, a maximum cropping, or any other maximum parameter or combination of parameters. When a controller 304 determines that a maximum adjustment would be exceeding, in some embodiments a warning may be sent through the user interface 102. In some embodiments a controller 304 can decline to perform any adjustment if the calculated adjustment would exceed a maximum parameter. In some embodiments controller 304 can perform adjustments up to the maximum parameter where the full calculated adjustments would exceed the maximum parameter.

An image orientation system 300 can provide an oriented image in a variety of ways. A controller 304 can deliver an oriented image to the display 310 where the image can be displayed for a user to view. A display 310 can be configured to interact with user interface 302 such that a user can input additional instructions while viewing the captured or oriented image. In some embodiments, the image display 310 can be one the faces of a smartwatch. In some embodiments, the image display 310 can be part of a smartphone. In some embodiments, the image display 310 can be a computer monitor, or a physical printer configured to display an image by printing a hard copy of the image. A controller 304 can deliver (e.g., via a wireless communication interface) an image to be displayed remotely. A controller 304 can deliver an image to a memory 312 for storage and potential future retrieval.

In some embodiments an oriented image can be shared (e.g., by controller 304 via a communication interface) according to user instructions. An image can be shared with or without the user first viewing the image on the display 310. A user can instruct a controller 304, in some embodiments via a user interface 302, to share a reoriented image, the original unadjusted image, or both. A controller 304 can deliver an image through a wired connection or through a wireless connection such as a Bluetooth wireless communication link, a Wi-Fi or a wireless local area network (WLAN) communication link, a wireless connection to a cellular system, a commercial communications radio link, a military radio link, or combinations thereof. In some embodiments an image can be delivered from the image orientation system 300 by inclusion in an email, by inclusion in a text message sent through a cellular system, or by being uploaded to a network. In some embodiments the shared or stored image can include metadata describing the orientation of the image and any adjustments made to the image.

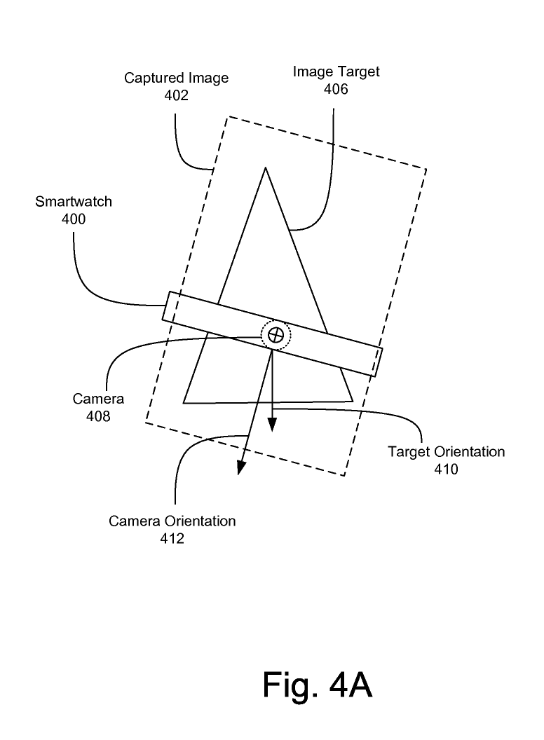

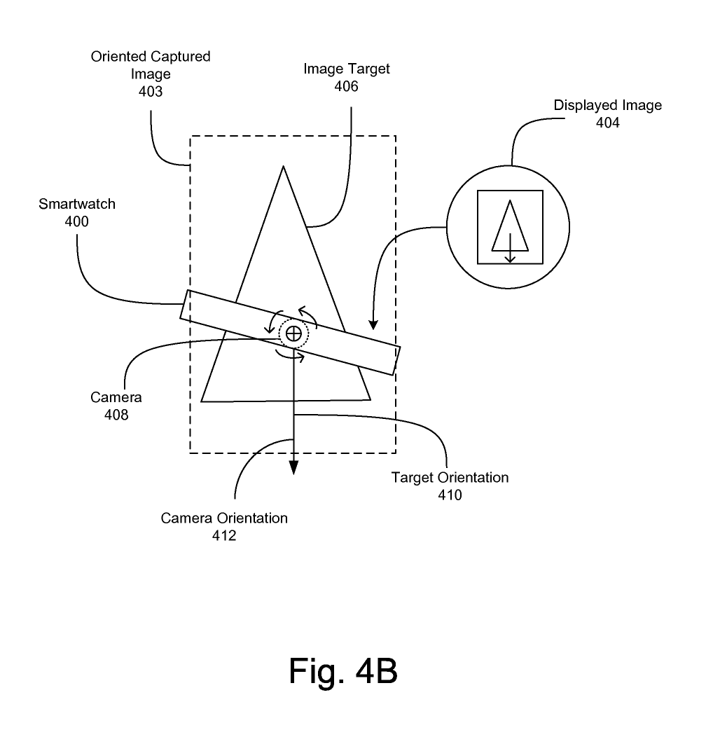

An image can also be oriented by adjusting the orientation of a camera before capturing the image. A device can be configured to detect the orientation of the device and/or a camera on the device and to move the camera (e.g., by rotating the camera about at least one axis) to adjust the orientation of the image to be captured. The axis can correspond to the line of sight of the camera. FIGS. 4A and 4B show an example of some embodiments where a camera 408 on a smartwatch 400 is rotated so that the camera orientation 412 aligns with the target orientation 410. As discussed above, the target orientation 410 can have the bottom of the image perpendicular to the measured directional pull of gravity.

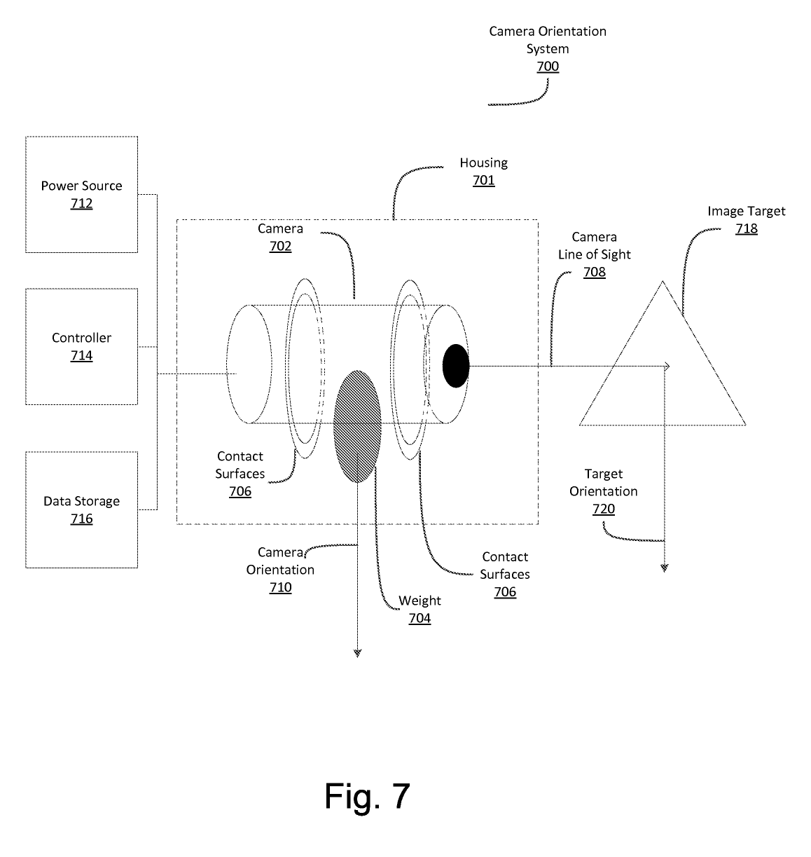

In FIG. 4A, a camera 408 can be aligned with the orientation of the smartwatch 400, for example, but the camera 408 can still be out of alignment with the target orientation 410. A captured image 402 in the configuration shown in FIG. 4A would accordingly also be out of alignment with the target orientation 410 because of the orientation of smartwatch 400. As shown in FIG. 4B, the camera 408 can rotate or otherwise moved (e.g., out of alignment with the smartwatch 400) into alignment with the target orientation 410. The configuration shown in FIG. 4B provides an oriented captured image 403 directly from the camera 408, which can be aligned with the target orientation 410. In some embodiments the camera 408 can be mechanically moved (e.g., rotated). In some embodiments, described below with reference to FIG. 7, the camera 408 can freely rotate about at least one axis in response to the force of gravity.

The rotation shown in FIG. 4B can in some embodiments be achieved by an actuator in the smartwatch 400. An actuator can be a small electric motor configured to move the camera 408 (e.g., to rotate the camera 408 about at least one axis). The axis of rotation can be the central axis corresponding to the line of sight of the camera 408. An orientation sensor can be used to determine the amount of rotation needed to orient the camera 408 with the target orientation 410, as discussed herein. As described above, the orientation sensor can be at least one accelerometer. In some embodiments an actuator can move (e.g., rotate) the camera according to the detected orientation in response to a user command to capture an image, and the camera 408 can capture the image after the camera 408 has been moved into alignment with the target orientation 410. In some embodiment, the entire camera 408 can rotate, or only a portion of the camera 408 that includes the image sensor can rotate.

In some embodiments an actuator can rotate a camera 408 according to a detected orientation before any request has been made to capture an image. For example, in some embodiments, the actuator can adjust the position of the camera 408 continuously, or substantially continuously, to maintain the camera 408 in alignment with the target orientation, which can enable the camera 408 to take a picture quickly after receipt of a user command without waiting for the camera 408 to move to an aligned position. An actuator in a smartwatch 400 can continuously, or substantially continuously, adjust the orientation of a camera 408 in response to a detected change in orientation. In some embodiments a user can enable continuous, or substantially continuous, adjustments by the actuator in connection with a request to record a stream of video images or to continuously display the image captured by the camera 408. In some embodiments, to conserve electrical power, the actuator may only perform an adjustment to the orientation of a camera 408 at set time intervals (e.g., even when instructed by a user to continuously update the camera orientation). The time interval between adjustments to the orientation of a camera 408 can in some embodiments be less than or equal to about 1 minute, 20 seconds, 15 seconds, 10 seconds, 5 seconds, 1 second, 0.5 seconds, 0.1 seconds, 0.05 seconds, or 0.01 seconds, and/or the time intervals can be greater than or equal to about 0.01 seconds, 0.05 seconds, 0.1 seconds, 0.5 seconds, or 1 second, although time intervals outside these ranges can also be used. In some embodiments, the timer interval between adjustments to the camera orientation 412 can be such that the adjustment is perceived to be continuous by a human observer.

An actuator can move (e.g., rotate) the camera 408 according to user instructions, and in some embodiments without the use of an orientation sensor. A user can instruct an actuator to move (e.g., rotate) the camera 408 an amount about at least one axis with or without reference to an orientation sensor to reflect a manual orientation preference of the user. In some embodiments the user may request a rotation of the camera 408 while viewing a displayed image 404, which can be part of a captured video stream of images. The displayed image 404 can reflect changes in the orientation of the camera 408 as the changes occur.

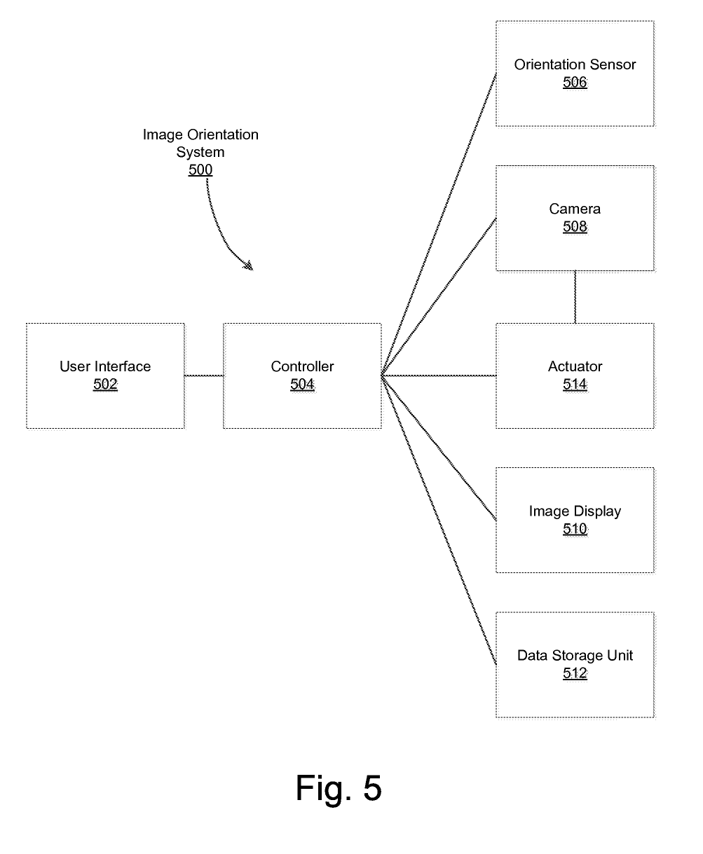

FIG. 5 shows an embodiment of an image orientation system 500 including an actuator 514 in addition to a user interface 502, a controller 504, an orientation sensor 506, a camera 508, a display 510, and a memory module 512. The components of the image orientation system 500 can be configured in any manner described in reference to the image orientation system 300 shown in FIG. 3. In addition to the configurations and functions described in reference to the image orientation system 300, the image orientation system 500 can be configured so that an actuator 514 can move (e.g., rotate) camera 508, as discussed herein.

An actuator 514 can cause camera 508 to rotate about at least one axis. An axis of rotation can be the central axis corresponding to the line of sight of the camera 508 and/or normal to the plane of an image captured by camera 508 and/or normal to an image sensor surface on the camera 508. An electric motor can serve as actuator 514, although various other suitable actuators can be used. An actuator 514 can be configured to rotate camera 508 within a stationary housing. In some embodiments, the housing for the camera 508 and the actuator 514 can be part of a mobile device (e.g., a smartphone, smartwatch, or hand-held digital camera).

The controller 504 can issue an instruction for an actuator 514 to rotate the camera 508. The amount of rotation for a camera 508 can be determined by a controller 504 according to a detected orientation from an orientation sensor 506, as discussed herein. The orientation sensor 506 can be at least one accelerometer. A controller 504 can be configured to determine the rotation needed to bring the camera orientation into alignment with the target orientation based on information received from the orientation sensor 506.

A user interface 502 can be configured to allow a user to enable or disable the use of an actuator 514 to rotate the camera 508. In some embodiments, an actuator 514 only rotates the camera 508 if an instruction is received from the user interface 502 to rotate the camera 508. The instructions to rotate a camera 508 can specify to rotate the camera 508 the calculated amount needed to bring the orientation of the camera 508 in line with the detected directional force of gravity. In some embodiments, the instructions to the actuator 514 to rotate the camera 508 can be to rotate the camera an amount specified by a user through user interface 502, which can be different from the amount needed to bring the orientation of the camera 508 in line with the detected directional force of gravity.

An instruction for an actuator 514 to move (e.g., rotate) the camera 508 can be given in response to a request to capture an image. An instruction to move (e.g., rotate) the camera 508 can be given independent of a request to capture an image. In some embodiments instructions can be given to actuator 514 via user interface 502 to rotate the orientation of the camera 508 while the camera 508 is capturing a stream of video images. In some embodiments a user can observe on the display 510 the effects of rotating a camera 508 while capturing a stream of video images with the camera 508. A user interface 502 can be configured to receive various requests while the display 510 is displaying a captured stream of video images from camera 508. In some embodiments, the user interface 502 can be configured to receive various instructions such as, for example, any of the following: capture an image currently displayed on the display 510; record the captured stream of video images from camera 508; rotate the camera 508 via the actuator 514; and/or crop and rotate the captured image according to the methods described above with reference to FIG. 1.

The user interface 502 can be configured to allow a user to enable dynamic rotation of the camera 508 by actuator 514. An actuator 514 can be configured to continuously, or substantially continuously, move (e.g., rotate) the camera 508 to adjust for any deviation of the orientation of the camera 508 from a target orientation detected by orientation sensor 506. Dynamic rotation of a camera 508 by an actuator 514 to adjust for a detected deviation in the orientation of the camera 508 can occur at specified time intervals as discussed herein. A user interface 502 can be configured to accept conditions for enabling or disabling dynamic rotation such as upon initiation of a request to capture an image or stream of video images. In some embodiments, dynamic rotation can be disabled if a specified low battery charge level is detected. In some embodiments, the actuator 514 can enable rotation of the camera 508 across a range of 360 degrees, such that the camera 508 can be positioned to align with the target orientation regardless of the position of the mobile device (e.g., a smartphone, smartwatch, or hand-held digital camera). In some embodiments, the actuator 514 can enable rotation of the camera 508 across 180 degrees, and the controller can be configured to invert the image, which can provide an effective full range of rotation for the camera 508.

The methods described above for reorienting a captured image with reference to image orientation system 300 such as cropping and rotating a captured image can be used in connection with image orientation system 500. In some embodiments, the available range of movement (e.g., rotation) of the camera 508 by actuator 514 can be insufficient to align the detected orientation of the camera 508 with a target orientation (e.g., such as the direction of the pull of gravity). For example, the actuator 514 can, in some embodiments, provide a rotational range of less than 360 degrees or less than 180 degrees. In some embodiments, when the target orientation is outside the available range of motion of the actuator 514, the controller 504 can capture an image using the camera 508 (e.g., with the camera 508 moved to the edge of the available range of motion), and the controller can reorient the capture image (e.g., by rotating and cropping the captured image) to achieve the target orientation.

In some embodiment, rather than continuously, or substantially continuously, making fine adjustments to the orientation of a camera 508, after an initial rotation by the actuator 514 an image can be captured by the camera 508 and adjusted by controller 504 (e.g., by rotating and cropping the image). In some embodiments, the adjustments by controller 504 can be cropping and rotating the captured image to have an orientation aligned with a desired orientation (e.g., with the bottom of the image perpendicular to the detected direction of the pull of gravity). The adjustments to a captured image (e.g., cropping and rotating) can be more effective for small orientation corrections while the rotation of camera 508 can be more effective for large orientation corrections. Accordingly, the controller 504 can be configured to achieve the target orientation by a combination of physical movement of the camera 508 and reorientation of the captured image.

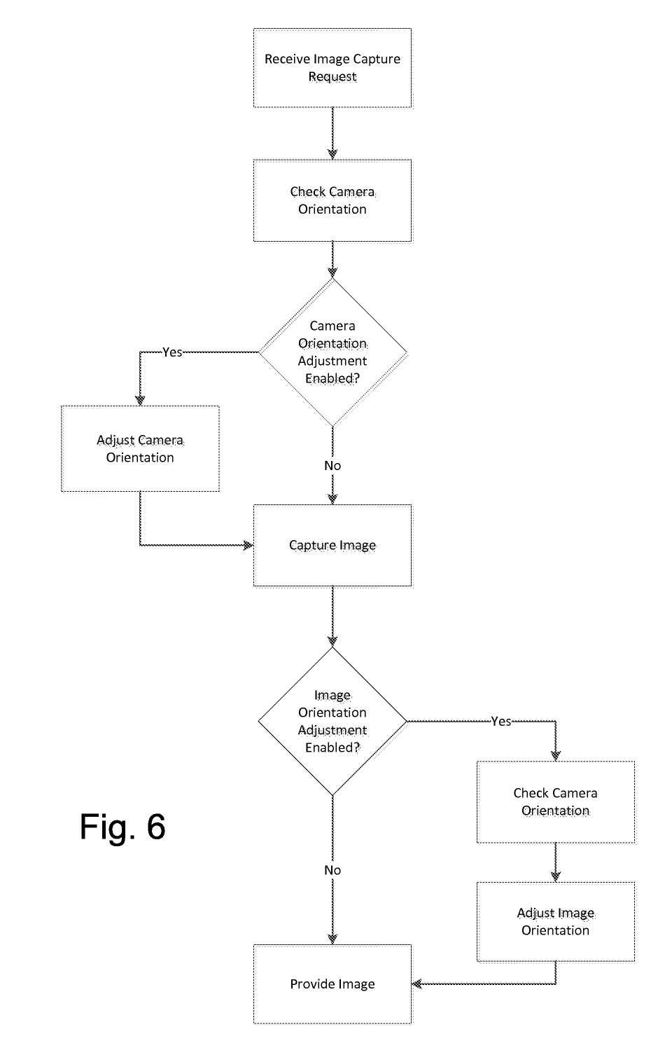

FIG. 6 shows a flowchart example of some embodiments of a method to provide an oriented image captured by a camera on a mobile device (e.g., a smartphone, smartwatch, or hand-held digital camera). At block 602, a request to capture an image can be received (e.g., via the user interface 502). The request can be to capture a single image, or in some embodiments can be to capture a stream of video images. At block 604, the orientation of the camera can be checked (e.g., using the orientation sensor 506).

If camera orientation adjustment is enabled (at block 606), then the camera orientation can be adjusted at block 610. In some embodiments adjusting the camera orientation can comprise rotating the camera 508 about at least one axis with an actuator 514. The rotation of the camera orientation can be equal to the determined angular displacement of the camera orientation from the target orientation (e.g., determined from the direction of the detected pull of gravity). After the camera orientation adjustment, or if the adjustment is not enabled, the camera 508 can capture an image at block 608.

After capturing an image with a camera 508, if image orientation adjustment is not enabled (at block 612), then the image can be provided (e.g., displayed on display 510 or saved in memory 512) at block 614. If image orientation adjustment is enabled (at block 612), then the camera orientation can be checked a second time, at block 616, to determine the camera orientation at the time the image was captured. Following the second orientation check, the image orientation can be adjusted to align with the target orientation (e.g., based on the detected direction of the force of gravity), at block 618. In some embodiments, adjusting the image orientation can include cropping and rotating the image to have an orientation aligned with the target orientation. Any method for adjusting the image orientation described herein can be used to adjust the image orientation. After any adjustments are made to the image, the last step can be providing the image at block 614.

To provide an image can mean to display an image on a local display, such as the screen of a mobile device (e.g., a smartphone, smartwatch, or hand-held digital camera). Providing an image can also mean storing an image in local or remote memory. An image can also be provided such that it can be shared across a wireless link with at least one remote device. A wireless link can be a Bluetooth connection, a connection to a wireless local area network, a connection to a cellular communications network, a radio communication link, or any other connection capable of transmitting signals or data wirelessly. In some embodiments, a captured image can be displayed on the screen of a smartphone wirelessly linked with the smartwatch and camera that captured the image. To provide an image can mean to share an image via text message, instant message, video chat, or email. In some embodiments to provide an image can mean to upload an image directly from a mobile device (e.g., a smartwatch) to a network, which can include uploading the image to a social media website such as Twitter, Instagram, Facebook, or Pinterest. An image can be provided more than one time and in more than one way.

Some steps described in FIG. 6 can be omitted, completed in a different order, or performed multiple times, and additional steps can be included. For example, in some embodiments, the camera orientation can be checked and adjusted continuously, or substantially continuously, before receiving an image capture request. In some embodiments, the system is not configured to adjust the physical position of the camera, and blocks 604, 606, and 610 can be omitted. In some embodiments, the system is not configured to reorient the image after capture, and blocks 612, 616 and 618 can be omitted. Many variations are possible. In some embodiments, the camera orientation can be adjusted multiple times before capturing an image, and the orientation of the camera can be checked between each such adjustment. If a stream of video images is captured and provided, then a second captured request can be made to separately provide a captured image frame from the continuous stream of video images. The second request to capture a frame from the stream of video images can be made while a user is observing the stream of images on a display. In some embodiments a user can interrupt the process or undo adjustments before providing an image. A user can make manual adjustments to an image or to the camera orientation.

FIG. 7 shows an example of some embodiments of a camera orientation system configured such that a camera 702 can rotate within a housing 701 (e.g., in response to the direction of the force of gravity). The housing 701 can be configured such that a camera 702 can capture images along the camera line of sight 708. Rather than mechanically adjusting the orientation of a camera 702 (e.g., using an actuator) or altering an image captured at a detected orientation, in some embodiments, a camera 702 can be configured to maintain a camera orientation 710 with the bottom of the camera approximately aligned with the direction of the force of gravity.

A housing 701 for a camera 702 can include multiple contact surfaces 706 where the housing and the camera 702 come in to contact. The contact surfaces 706 can be configured to allow camera 702 to rotate about a central axis. The central axis can be the camera's line of sight 708. In the example shown in FIG. 7, the contact surfaces 706 include two annular portions encircling a cylindrical camera 702, with a weight attached to the camera 702 (e.g., between the two contact surfaces 706). The annular contact surfaces 706 can keep the camera 702 oriented along the same line of sight 708 but can provide rotational freedom. Although not pictured, in some embodiments, additional contact between the camera 702 and the housing 701 can occur at either end of the camera to limit the lateral movement of the camera 702 within the housing. In some embodiments, different shapes can be used for the contact surfaces 706 and the camera 702, such as spherical camera 702 or thin plates for contact surfaces 706, while still configured to allow rotational freedom about a central axis.

The contact surfaces 706 and the camera 702 can be configured such that the friction on the camera 702 is substantially less than the force of gravity acting on weight 704. Friction can be reduced by using specific materials or configurations designed to have low coefficients of friction. In some embodiments, the contact surfaces 706 can comprise brushes or bearings to allow rotation of a camera 702 with reduced friction. A camera 702 can in some embodiments comprise grooved portions where the contact surfaces 706 meet the camera 702, and the contact surfaces can partially interlock with the grooved portions on the camera 702.

The camera 702 can be configured to rotate about camera line of sight 708 in response to the force of gravity on an off-axis weight 704 that is aligned with the vertical axis of the camera 702. The weight 704 can be positioned off of the axis of rotation so that when the weight 704 is not oriented toward the pull of gravity a net torque will cause the camera 702 to rotate. In some embodiments weight 704 can be a lateral strip running off axis and parallel to the camera line of sight 708. The weight 704 can be configured on camera 702 such that the camera orientation 710 is defined as a line extending radially from and perpendicular to the camera line of sight 708 through the center of mass for a weight 704.

The weight 704 on camera 702 can be heavy enough that the force of gravity acting on the weight 704 can overcome forces opposing the rotation of camera 702 such as friction. A weight 704 can in some embodiments be heavy enough to correct for rotational asymmetries in the internal mass of the camera 702. In some embodiments weight 704 can physically extend out of the camera 702, as shown in FIG. 7, or the weight 704 can be contained within the camera 702. The contact surfaces 706 of the housing 701 can be configured to avoid interfering with the rotation of weight 704 on the camera 702. In some embodiment, the entire camera 702 can rotate, or only a portion of the camera 702 that includes the image sensor can rotate.

The camera 702 inside the housing 701 can separately maintain its orientation, even if the housing 701 is held out of alignment with the target orientation 720. An image captured by camera 702 of an image target 718 can be oriented in the same direction as the target orientation 720 (e.g., such that a bottom of an image captured by the camera 702 has a bottom that is perpendicular to the force of gravity) regardless of the orientation of the housing 701. In some embodiments, where the housing 701 is part of a mobile device (e.g., a smartphone, smartwatch, or hand-held digital camera), the continuous freedom to rotate can allow a user to capture an image with a target orientation 720 even when it would not be practical for the user to hold the camera aligned with the target orientation 720 (e.g., by holding his or her wrist having a smartwatch camera aligned with the target orientation 720). Although not pictured in FIG. 7, a locking mechanism or brake can be included that, when engaged, prevents further rotation of camera 702.

The camera 702 can communicate with other devices or portions of a device (e.g., outside of the housing 701). In some embodiments a camera 702 interacts with a power source 712, a controller 714, and/or a memory module 716. Although not pictured in FIG. 7, a camera 702 can also interact with a variety of other devices or modules such as a display module, a physical actuator, a wireless communication module, and/or a user interface. In some embodiments, these devices or modules can be part of the mobile device (e.g., a smartphone, smartwatch, or hand-held digital camera) comprising housing 701 and camera 702. In some embodiments some devices or modules in addition to the camera 702 can be included in housing 701.

Instructions from a controller 714 can be communicated to a camera 702. Although not pictured in FIG. 7, the instructions can be generated by a user through a user interface, as described herein. Instructions from the controller 714 can include requests to capture an image or capture a stream of video images. The controller 714 can direct the interactions of camera 702 with other devices or modules such as a power source 712 or a memory module 716. A camera 702 can also communicate captured images to controller 714, or in some embodiments with a memory module 716. The memory module 716 can be a local or remote data storage unit configured to record a captured image or stream of video images (e.g., as digital data).

A power source 712 can supply electrical power to the camera 702. In some embodiments, the power source 712 can be a battery physically connected to a camera 702 and/or within the housing 701. In some embodiments, wire can connect a power source 712 outside of the housing 701 to the camera 702. Electrical power can be transferred to a camera 702 in the housing 701 wirelessly from a power source 712, and in some embodiments the wireless power transfer can utilize magnetic induction.

The connections between the modules or devices (e.g., outside the housing 701) and a camera 702 can be configured to avoid limiting the rotational freedom of the camera 702. Connections from a camera 702 with a module or device outside the housing 701 can be wireless. In some embodiments one or more additional devices or modules can be incorporated with the camera 702 in the housing 701 to have rotational freedom about the central axis. Where a connection from the camera 702 to one or more modules or devices outside the housing 701 is made with a wire, the wired connection can be configured to avoid obstructing the rotation of the camera 702. In some embodiments a wired connection can be configured to connect with a point on a camera 702 that has minimal displacement during rotation of the camera 702, such as a point on the central axis of rotation. In some embodiments the housing 701 can be configured to prevent rotation of the camera 702 within the housing beyond 360 degrees in one direction so as to prevent any problem from the wired connections being repeatedly twisted.

In some embodiments the rotation of a camera 702 with respect to a central axis due to a weight 704 may not be sufficient to always bring the camera orientation 710 in to alignment with a target orientation 720. The camera orientation system 700 can be combined with the other methods and systems discussed above with reference to any other Figures. In some embodiments, not pictured, an orientation sensor can be included with the camera orientation system 700 to determine whether and what adjustments may be further required to orient a captured image. A controller 714 can be configured to apply any cropping and rotating, as described for various embodiments above, needed to adjust the orientation of a captured image to the target orientation 720. In some embodiments where the housing 701 is configured to only allow rotation of a camera 702 within a specific range, an actuator can be used to further rotate the housing 701, the camera 702, or both.

The systems and methods disclosed herein can be implemented in hardware, software, firmware, or a combination thereof. Software can include computer-readable instructions stored in memory (e.g., non-transitory, tangible memory, such as solid state memory (e.g., ROM, EEPROM, FLASH, RAM), optical memory (e.g., a CD, DVD, Blu-ray disc, etc.), magnetic memory (e.g., a hard disc drive), etc.), configured to implement the algorithms on a general purpose computer, special purpose processors, or combinations thereof. For example, one or more computing devices, such as a processor, may execute program instructions stored in computer readable memory to carry out processes disclosed herein. Hardware may include state machines, one or more general purpose computers, and/or one or more special purpose processors. While certain types of user interfaces and controls are described herein for illustrative purposes, other types of user interfaces and controls may be used.

The embodiments discussed herein are provided by way of example, and various modifications can be made to the embodiments described herein. Certain features that are described in this disclosure in the context of separate embodiments can also be implemented in combination in a single embodiment. Conversely, various features that are described in the context of a single embodiment can be implemented in multiple embodiments separately or in various suitable subcombinations. Also, features described in connection with one combination can be excised from that combination and can be combined with other features in various combinations and subcombinations.

Similarly, while operations are depicted in the drawings or described in a particular order, the operations can be performed in a different order than shown or described. Other operations not depicted can be incorporated before, after, or simultaneously with the operations shown or described. In certain circumstances, parallel processing or multitasking can be used. Also, in some cases, the operations shown or discussed can be omitted or recombined to form various combinations and subcombinations.

What is claimed is:

1. A camera system comprising:
a camera configured to capture an image;
an orientation sensor configured to determine an orientation of the camera; and
a controller configured to orient the image based at least in part on the orientation of the camera.

2. A wearable computing device comprising:
the camera system of claim 1; and
a coupling element configured to couple the wearable computing device to a wearer, wherein the wearable computing device is configured to capture an image using the camera while the wearable computing device is worn by the wearer.

3. The wearable computing device of claim 2, wherein the wearable computing device comprises a smartwatch.

4. The camera system of claim 1, further comprising a computer readable memory, wherein the controller is configured to store the captured image in the computer readable memory.

5. The camera system of claim 4, wherein the controller is configured to store metadata associated with the captured image in the computer readable memory, the metadata comprising orientation data comprising the orientation of the camera.

6. The camera system of claim 1, wherein the camera comprises a substantially circular image sensor.

7. The camera system of claim 1, wherein the controller is configured to orient the image by modifying the image after the camera captures the image based at least in part on the orientation of the camera.

8. The camera system of claim 1, wherein the controller is configured to orient the image by rotating and/or cropping the image after the camera captures the image.

9. The camera system of claim 1, wherein the orientation sensor comprises an accelerometer.

10. The camera system of claim 1, further comprising an actuator for moving at least part of the camera, and wherein the controller is configured to orient the image by moving the at least part of the camera using the actuator based at least in part on the orientation of the camera before the camera captures the image.

11. The camera system of claim 10, wherein the actuator is configured to rotate the at least part of the camera to orient the image.

12. The camera system of claim 1, further comprising a user interface configured to receive input, and wherein the controller is configured to enable and disable image reorientation in response to input received by the user interface.

13. The camera system of claim 1, wherein the image comprises one frame of a video recording.

14. The camera system of claim 13, wherein the camera is configured to capture multiple images comprising multiple frames of the video recording, wherein the orientation sensor is configured to determine the orientation of the camera for each of the multiple images, and wherein the controller is configured to orient each of the multiple images based at least in part on the orientation of the camera for each of the multiple images.

15. The camera system of claim 13, wherein a first set of images of the video recording are captured in a first orientation, wherein a second set of images of the video recording are captured during a transition from the first orientation to a second orientation, wherein a third set of images of the video recording are captured in the second orientation, wherein the orientation sensor is configured to determine the orientation of the camera for the first set of images, for the second set of images, and for the third set of images, and wherein the controller is configured to reorient at least some of the images based at least in part on the determined orientation of the camera such that the first set of image, the second set of image, and the third set of images have the same orientation.

16. The camera system of claim 15, wherein the first orientation is rotationally offset from the second orientation by an angle between about 70 degrees and about 110 degrees.

17. The camera system of claim 15, wherein the first orientation is one of a landscape orientation and a portrait orientation, and wherein the second orientation is the other of the landscape orientation and the portrait orientation.

18. A smartwatch comprising:
a wrist strap configured to couple the smartwatch to a wrist of a wearer;
a camera configured to capture a first image;
an orientation sensor configured to determine the orientation of the camera;
a data storage element; and
a controller configured to:
determine a displacement angle between the orientation of the camera determined by the orientation sensor and a target orientation; and
produce a second image that is rotationally offset from the first image by an amount of the displacement angle.

19. The smartwatch of claim 18, wherein the controller is configured to rotate and crop the first image to produce the second image.

20. The smartwatch of claim 18, wherein the controller is configured to store the second image in the data storage element.

21. The smartwatch of claim 18, wherein the orientation sensor comprises an accelerometer.

22. The smartwatch of claim 18, wherein the bottom edge of the second image is substantially perpendicular to a measured force of gravity.

23. The smartwatch of claim 18, further comprising a wireless communication interface configured to transmit the second image to a remote device.

24. The smartwatch of claim 18, further comprising a display configured to display the second image.

25. The smartwatch of claim 18, wherein the camera is configured to capture the first image having a substantially circular shape.

26. The smartwatch of claim 18, wherein the controller is configured to produce the second image such that the first image is larger than the second image by at least about 20% and by about 200% or less.

27. The smartwatch of claim 18, wherein the controller is configured to produce the second image smaller than the first image such that the second image fits inside the first image in any rotational orientation.

28. A method for providing an image, the method comprising:
receiving an instruction to capture an image;
capturing a first image using a camera;
determining an orientation of the camera using an orientation sensor; and
producing a second image based at least in part on the first image and the orientation of the camera.

29. The method of claim 28, wherein a smartwatch comprises the camera.

30. The method of claim 28, further comprising determining a displacement angle between the orientation of the camera and a target orientation, wherein the second image is rotationally offset from the first image by an amount of the displacement angle.
